(19) United States
(12) Patent Application Publication
(10) Pub. No.: US 2018/0146445 A1
(43) Pub. Date: May 24, 2018

(54) ASYNCHRONOUS MULTIPLE ACCESS METHOD AND DEVICE FOR LOW LATENCY SERVICE

(71) Applicant: LG ELECTRONICS INC., Seoul (KR)

(72) Inventors: Hojae LEE, Seoul (KR); Hyunsoo KO, Seoul (KR); Kukheon CHOI, Seoul (KR); Kwangseok NOH, Seoul (KR); Dongkyu KIM, Seoul (KR); Sangrim LEE, Seoul (KR)

(21) Appl. No.: 15/572,030

(22) PCT Filed: Mar. 22, 2016
(86) PCT No.: PCT/KR2016/002836

§ 371 Date: Nov. 6, 2017

Related U.S. Application Data
(60) Provisional application No. 62/158,524, filed on May 7, 2015.

(51) Int. Cl. H04W 56/00; H04W 74/00; H04W 72/04

(52) U.S. Cl. CPC H04W 56/0055; H04W 88/08; H04W 72/042; H04W 74/006

(57) ABSTRACT

Disclosed is an asynchronous multiple access method and device for a low latency service. The asynchronous multiple access method for low latency service may include the steps of: grouping, by an eNB, each of a plurality of UEs into one UE group among a plurality of UE groups in consideration of each of a plurality of propagation delays of each of the plurality of UEs; receiving, by the eNB, each of a plurality of pieces of uplink data transmitted by each of the plurality of UE groups on each of a plurality of wireless resources allocated for each of the plurality of UE groups at an internal access timing; and transmitting, by the eNB to each of the plurality of UE groups, each of a plurality of ACKs/NACKs signals in response to each of a plurality of uplink frames, wherein the internal access timing can be periodically defined in a symbol unit for the synchronization of transmitting times of the plurality of pieces of uplink data.

### BACKGROUND OF THE INVENTION

### Field of the Invention

The present invention relates to an access method of a User Equipment (UE), and more particularly, to an asynchronous-based multiple access method and apparatus for a low latency service.

### Related Art

The 5G (generation) mobile communication is a next generation mobile communication technology that is 1000 times faster than the 4G (generation), and has a transmission rate of 1 Gbps (gigabits per second) per person and a service latency time of less than several microseconds. The 5G mobile communication is being discussed based on the following trends of mobile services.

Recently, as the demands for multimedia and social network services explosively increases, the amount of mobile traffic is increasing at an incredible rate, and the number of things is also continuously increasing due to the emergence of Internet of Things (IoT). Accordingly, the traffic amount is expected to more explosively increase.

Also, the number of mobile devices and things connected to the Internet is expected to explosively increase.

In addition, as a user demand for a cloud computing system increases, transition from the PC age to the mobile cloud computing age is expected to accelerate.

Furthermore, 5G mobile services are expected to be changed into forms that provide necessary services to users based on the mobile cloud computing system. In addition, due to the appearance of a variety of mobile convergence technologies, various mobile convergence services such as augmented reality/virtual reality, ultra high precision location-based services, hologram services, and smart health care services are expected to emerge.

The 5G mobile communication system needs to be necessarily designed in consideration of the four major megatrends (increase in traffic, increase in number of devices, increase in dependency on cloud computing, and appearance of various 5G-based convergence services) mentioned above. In consideration of these details, various countries and companies are recently proposing basic performance indicators for 5G mobile communication systems. In order to improve the user feeling performance in 5G (generation) system, the International Telecommunication Union-Radio communication Sector (ITU-R) Working Party (WP) 5D provides roughly three scenarios according to the requirements such as broadband transmission of maximum transmission rate of 20 Gbps per user/more than 100 Mbps, large-scale connectivity enabling connection of more than 1 million devices per 1 km², and ultra-low latency and ultra-reliability of 1 ms in a wireless access section.

### SUMMARY OF THE INVENTION

The present invention provides an asynchronous-based multiple access method for low latency services.

The present invention also provides an apparatus for performing an asynchronous-based multiple access method for low-delay services.

In an aspect, an asynchronous-based multiple access method for a low latency service includes: grouping, by an eNB (eNode B), each of a plurality of User Equipments (UEs) into one UE group of a plurality of UE groups in consideration of each of a plurality of propagation delays of each of the plurality of UEs; receiving, by the eNB, each of a plurality of uplink data transmitted by each of the plurality of UE groups on each of a plurality of radio resources allocated for each of the plurality of UE groups at an implicit access timing; and transmitting, by the eNB, each of a plurality of acknowledgment (ACK)/non-acknowledgment (NACK) signals in response to each of a plurality of uplink frames to each of the plurality of UE groups, wherein the implicit access timing is periodically defined into units of symbols for synchronization of transmission time points of the plurality of uplink data.

In another aspect, an eNode B (eNB) for an asynchronous-based multiple access for a low latency service includes a Radio Frequency (RF) unit communicating with a UE (User Equipment); and a processor operably connected to the RF unit, wherein the processor groups each of a plurality of UEs into one UE group of a plurality of UE groups in consideration of each of a plurality of propagation delays of each of the plurality of UEs, receives each of a plurality of uplink data transmitted by each of the plurality of UE groups on each of a plurality of radio resources allocated for each of the plurality of UE groups at an implicit access timing, and transmits each of a plurality of acknowledgment (ACK)/non-acknowledgment (NACK) signals in response to each of a plurality of uplink frames to each of the plurality of UE groups, and the implicit access timing is periodically defined into units of symbols for synchronization of transmission time points of the plurality of uplink data.

### BRIEF DESCRIPTION OF THE DRAWINGS

FIG. 1 is a conceptual view illustrating a contention-based multiple access method in a wireless communication system.

FIG. 2 is a conceptual view illustrating a delay according to an uplink processing procedure in an LTE system.

FIG. 3 is a conceptual view illustrating a random access method based on an implicit timing of a UE according to an embodiment of the present invention.

FIG. 4 is a conceptual view illustrating timing operations of a transmitting end and a receiving end according to an embodiment of the present invention.

FIG. 5 is a conceptual view illustrating a method for reducing a reception timing offset according to an embodiment of the present invention.

FIG. 6 is a conceptual view illustrating a method of transmitting uplink data of a plurality of UEs through a frequency spread resource according to an embodiment of the present invention.

FIG. 7 is a flowchart illustrating a signal flow for an ultra low latency service according to an embodiment of the present invention.

FIG. 8 is a conceptual view illustrating signaling for an ultra low latency service in a multiple access method according to an embodiment of the present invention.

FIG. 9 is a view illustrating a wireless device to which an embodiment of the present invention may be applied.

### DESCRIPTION OF EXEMPLARY EMBODIMENTS

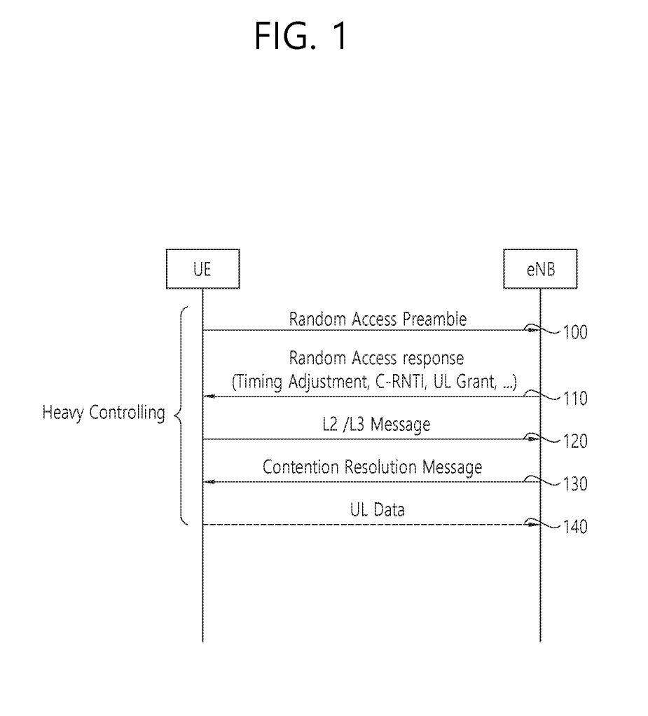

FIG. 1 is a conceptual view illustrating a contention-based multiple access method in a wireless communication system.

In FIG. 1, an uplink access method in a Long-Term Evolution (LTE) communication system is disclosed. This contention-based access method may also be used for ad hoc networks such as Device to Device (D2D) or Vehicular to Everything (V2X) and other cellular-based channel accesses such as LTE-Advanced (LTE-A) and Machine Type Communication (MTC).

The contention-based multiple access method may start when a user equipment (UE) performs a scheduling request (SR) from an e-Node B (eNB) based on a random access preamble 100 and the UE receives scheduling information from the eNB through a random access response 110. The scheduling information that the UE receives from the eNB may include timing adjustment (or timing advance; TA) information for synchronization between received signals from multiple users, cell identifier (cell ID) information, and grant information (e.g., transmission through a physical downlink control channel (PDCCH) as control information including modulation and coding scheme (MCS) level information or resource allocation (RA) information) for an uplink access.

In general, a communication system is a communication system in which a plurality of UEs use limited radio resources, while one UE may not know the state of another UE. Accordingly, a plurality of UEs may request random access (RA) on the same radio resource. Also, the eNB may resolve contention for radio resources requested by the plurality of UEs, and may transmit the information through a contention resolution message (130). In addition, the eNB and the UE may exchange control information for a network connection and a Hybrid Automatic Repeat and Request (HARQ) based on an L (layer) 2/L3 message 120 and transmit the uplink data 140.

In the next generation 5G (Generation) system, V2X, emergency service, and machine control are considered to provide ultra-low latency service. The ultra-low latency services may be very limited in latency requirements for end-to-end (E2E), and may require high data rate. For example, the E2E latency may be required to be less than about 1 ms, and the DL data rate may be required to be about 50 Mbps (megabit per second). Also, the UL data rate may be required to be about 25 Mbps. Generally, the E2E latency may be determined by network delay, processing delay, and air interface delay.

Typical contention-based multiple access methods necessarily require heavy controlling as shown in FIG. 1, and the air interface delay may be large.

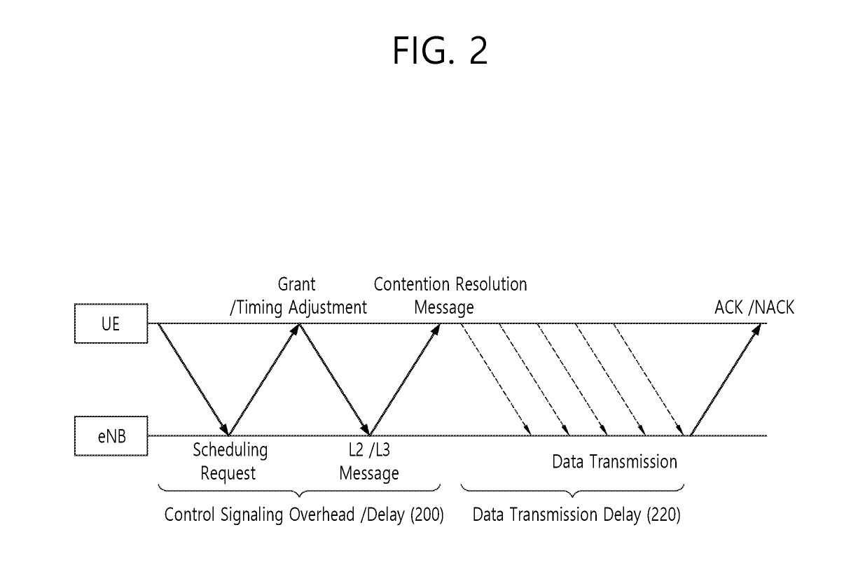

FIG. 2 is a conceptual view illustrating a delay according to an uplink processing procedure in an LTE system.

In FIG. 2, a control signaling delay 200 and a data transmission delay 220 according to an uplink procedure in the LTE system are disclosed.

Accordingly, a multiple overlapped access method may be needed to simplify the control procedure for the ultra-low latency service and to improve the data transmission rate by effectively resolving the contention. In the multiple overlapped access method, a plurality of UEs attempt to access the eNB through overlapped radio resources to transmit a plurality of uplink data, and the eNB may separately receive a plurality of uplink data.

Hereinafter, in an embodiment of the present invention, a multiple overlapped access control method for simplifying an initial control signaling procedure for multiple access for ultra-low latency service and ensuring the transmission of immediate uplink data of the UE is disclosed.

In particular, for ultra-low latency services in the present invention, the time for initial control signaling (e.g., timing advance and uplink grant reception) for uplink transmission may be reduced, and the reception time of acknowledgment (ACK)/non-acknowledgment (NACK) for uplink data transmission may be reduced.

In an embodiment of the present invention, disclosed is a method for controlling asynchronism of a plurality of UEs performing multiple overlapping connection that occurs when timing advance is not performed in order to reduce time for initial control signaling and for supporting transmission of uplink data of the plurality of UEs without receiving a scheduling request and an uplink grant. Also, disclosed is a method for minimizing a UE's traffic delivery completion time to reduce the reception time of an ACK/NACK transmitted in response to the transmission of uplink data.

Hereinafter, an asynchronous multiple overlapped access method of reducing initial control signaling for transmitting uplink data based on random access is disclosed.

In a typical LTE system, in order to reduce the time for initial control signaling, upon generation of an uplink data transmission traffic to be transmitted by each UE, when TA (timing advance) information is not received from the eNB and performs immediate transmission for the uplink data to the eNB while scheduling for uplink transmission is not performed, a limitation that the reception synchronism of the uplink data transmitted by the plurality of UEs does not match and a collision limitation between the multiple user data may occur at the eNB.

Although a multiple overlapped access method (e.g., Interleave Division Multiple Access (IDMA), Sparse Code Multiple Access (SCMA) or Power Level Non-Orthogonal Multiple Access (NOMA)) which is robust against collision of uplink data transmitted through the same radio resource (same time resource) by a plurality of UEs and the asynchronous uplink transmission is used, asynchronism of uplink data transmitted by the plurality of UEs at an eNB terminal that is a receiving end may make it difficult to distinguish between the plurality of UEs, and may cause a decrease in the decoding rate of the uplink data. Accordingly, a multiple overlapped access method for controlling asynchronous uplink transmission is needed. The multiple overlapped access method, like the methods described above, may be a multiple access method through division of overlapping signals through orthogonal or non-orthogonal codes, multiple user data, division of overlapping signals through a difference of transmission power, or division of overlapping signals through intermittent overlapping pattern of resources (e.g., Interleaver) while multiple user data share the same time-frequency resource and are transmitted.

Hereinafter, a method for solving an asynchronous limitation between a plurality of UEs caused by a reduction of control signaling for supporting an ultra-low latency service is disclosed in an embodiment of the present invention.

An asynchronous limitation caused by not performing initial control signaling when a plurality of UEs perform uplink transmission through the same radio resource on the basis of a multiple overlapped access method may be resolved based on a predefined implicit timing (or implicit access timing). Specifically, when uplink data to be transmitted to the eNB occur, the plurality of UEs may transmit an uplink traffic through synchronization of symbol unit based on a predefined periodic timing. The transmission of uplink data of the plurality of UEs may be synchronized based on this predefined periodic timing.

Also, the eNB sets a UE group by grouping (user grouping or UE grouping) UEs having similar propagation delay times, and allocates UEs included in the same UE group to the same resource zone (or region), such that the timing offset of the plurality of uplink data transmitted by each of the plurality of UEs received at the eNB can be controlled within a cyclic prefix (CP).

UE grouping of the UEs may be performed by the eNB by a predefined timing distance. The timing distance may be defined based on the size of the timing offset of uplink data transmitted by the plurality of UEs.

The eNB may allocate in advance a separate radio resource zone for each UE group, and a plurality of uplink data transmitted by the plurality of synchronized UEs may be divided based on a multi-user detection (MUD) method. According to an embodiment of the present invention, a plurality of synchronized uplink data may be transmitted based on the implicit access timing without a timing advance (TA) and an uplink grant by the eNB, and in this case, collisions between the plurality of uplink data may be divided based on the MUD.

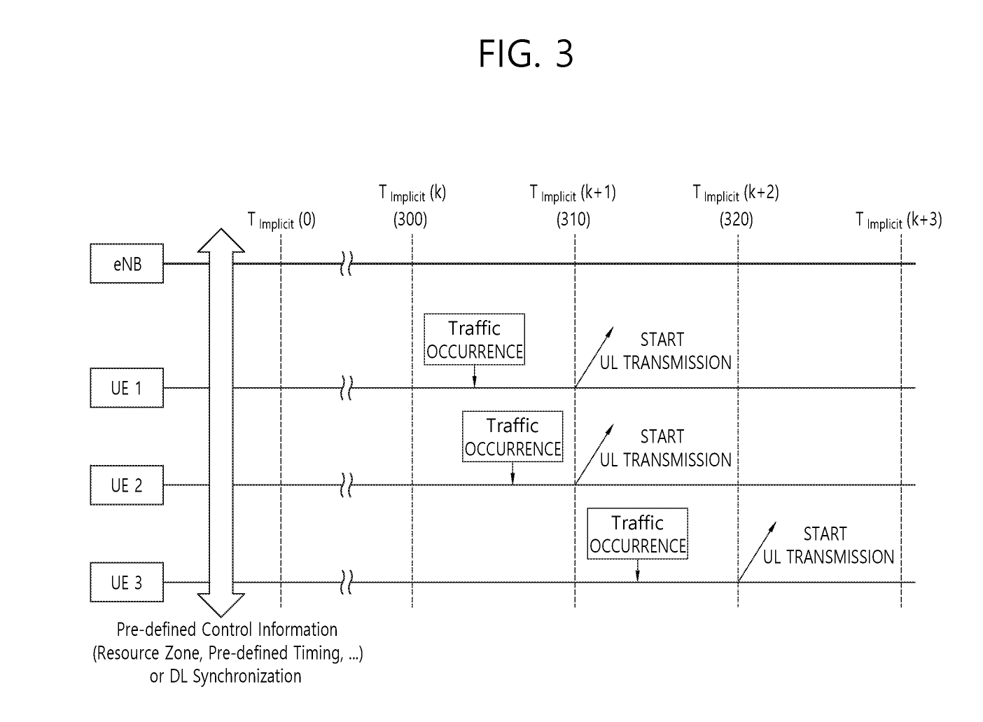

FIG. 3 is a conceptual view illustrating a random access method based on an implicit timing of a UE according to an embodiment of the present invention.

In FIG. 3, a channel access based on the multiple overlapped access method on the UE's implicit access timing for controlling asynchronism of a random access is disclosed.

Referring to FIG. 3, the eNB and each UE may share timing for predefined access (or random access). Hereinafter, the timing for predefined access between the eNB and each UE may be defined as a term called implicit access timing.

The implicit access timing may be defined by a symbol unit, and the period of the implicit access timing may be different according to a symbol duration of a system environment. The implicit access timing may have periodicity, and the period of the implicit access timing may be defined in various units such as a symbol, a subframe, and a frame.

The UE requesting immediate transmission of the uplink data may transmit the uplink data to the eNB at the implicit access timing closest to the time point when the uplink data occur. The implicit access timing may also be determined based on the synchronization timing for the downlink, or may also be determined with an absolute time determined through pre-defined control information transmitted and received between the eNB and all the UEs in advance.

For example, the implicit access timing may be defined as T_{Implicit} (N)=T+T_{symbol}*N based on the absolute time reference T. Here, N=0, . . . ∞, and T_{symbol} may denote a length of a symbol including a cyclic prefix (CP) length, or a length of a subframe or a frame.

Referring to FIG. 3, when uplink data of each of UE1 and UE2 to the eNBs occur between T_{Implicit} (k) 300 and T_{Implicit} (k+1) 310, UE1 and UE2 may each transmit the uplink data at the T_{Implicit} (k+1) 310 that is the closest implicit access timing.

When the uplink data of UE3 to the eNB occurs between T_{Implicit} (k+1) 310 and T_{Implicit} (k+2) 320, the UE3 transmits uplink data to the eNB at T_{Implicit} (k+2) 320 that is the closest implicit access timing.

Since the implicit access timing maintains synchronization by unit of symbol, symbol synchronization may be ensured from a transmission viewpoint even if uplink data (or uplink traffic) occurs at different time points in each of the plurality of UEs. An uplink transmission latency may occur by a maximum of T_{symbol} 71.4 us) in each UE.

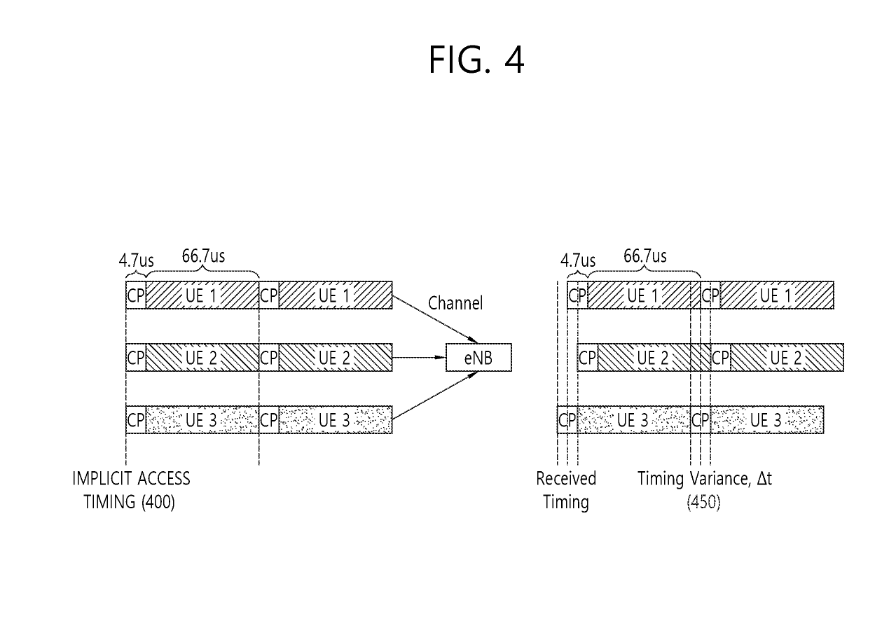

FIG. 4 is a conceptual view illustrating timing operations of a transmitting end and a receiving end according to an embodiment of the present invention.

In FIG. 4, disclosed is a reception timing mismatch of a plurality of uplink data received at the eNB due to distance differences between each of the plurality of UEs and the eNB when each of a plurality of UEs transmits each of a plurality of uplink data at the same implicit access timing.

Referring to FIG. 4, a transmission time point of a plurality of uplink data (uplink traffic) of each of a plurality of UEs may be equally maintained on the basis of an implicit access timing 400. However, the eNB receiving each of the plurality of uplink data may receive each of the plurality of uplink data at different timings due to the physical distance and the multipath channel that each UE undergoes.

In this case, a timing variance (ΔT) (or a reception timing offset) 450 of each of the plurality of uplink data transmitted by each of the plurality of UEs occurs in the eNB. Accordingly, a method for controlling the timing variance (ΔT) within a CP duration is needed.

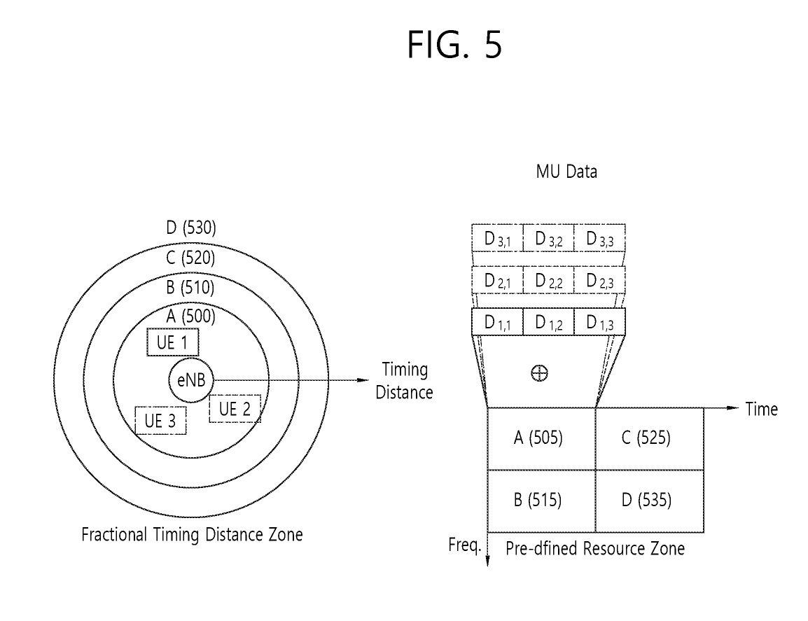

FIG. 5 is a conceptual view illustrating a method for reducing a reception timing offset according to an embodiment of the present invention.

In FIG. 5, when the access method based on the implicit access timing is performed, the eNB may group UEs having similar propagation delay times (user grouping, UE grouping) to set a UE group. The eNB allocates UEs included in the same UE group to the same resource zone (or region), such that the timing offset of the plurality of uplink data transmitted by each of the plurality of UEs received by the eNB can be controlled within a cyclic prefix (CP).

The eNB may determine the timing distance of the UE periodically or upon transmission of downlink data (or downlink traffic) to the UE or upon reception of uplink data (or uplink traffic) from the UE. The timing distance of the UE may be determined not only by the physical distance, but also by the propagation delay due to the multipath of the UE or the system environment. The timing distance may be determined based on the reception timing offset when the uplink data are transmitted to the eNB by the UE.

Referring to FIG. 5, the eNB may determine a fractional timing distance zone, and may perform UE grouping in consideration of timing distances of each of a plurality of UEs. For example, when the reception timing offset of ΔT is controlled based on the CP duration, the eNB may assume that the UEs with a reception timing offset of 0-ΔT are in a timing distance zone A (500) due to the propagation delay time by physical distance or multipath, and may perform UE grouping to determine a first UE group. That is, the first UE group may include at least one UE whose propagation delay time corresponds to 0-ΔT.

In a similar manner, the eNB may perform UE grouping assuming that a plurality of UEs whose propagation delay times are included in ΔT−2*ΔT are in a timing distance zone B (510). Accordingly, a difference in reception timing between a plurality of uplink data transmitted on the basis of the multiple overlapped access method by a second UE group including the plurality of UEs included in the timing distance zone B (510) may be ΔT that is a difference value between 2*ΔT and ΔT in terms of the eNB receiving the uplink data. Accordingly, the plurality of uplink data transmitted by the second UE group may have a reception timing offset within the CP duration.

In the same manner, the eNB may assume that a plurality of UEs whose propagation delay time is included in the 2*ΔT-3*ΔT is in a timing distance zone C (520), and may determine the plurality of UEs included in the timing distance zone C as a third UE group. Also, the eNB may assume that a plurality of UEs whose propagation delay time is included in the 3*ΔT-4*ΔT is in a timing distance zone D (530), and may determine the plurality of UEs included in the timing distance zone D as a fourth UE group.

In this case, ΔT for determining the timing distance zone may be variously defined according to the system environment (e.g., cell radius or CP duration). As the size of ΔT decreases, the timing offset of the reception view point may be reduced, but the timing distance zone may be subdivided and the number of UE groups may increase. Accordingly, the complexity of the system operation may increase as the size of ΔT decreases. On the other hand, as the size of ΔT increases, the timing offset of the reception end view point may increase, but the timing distance zone may be simplified and the number of UE groups may decrease, thereby reducing the complexity of the system operation.

Also, when ΔT larger than the CP duration is set, the eNB receiving a plurality of uplink data transmitted from a plurality of UEs based on the multiple overlapped access method may distinguish the plurality of uplink data through a rake receiver, and may perform the inverse Fourier transform (inverse Fourier transform) on each individual signal to detect a plurality of uplink signals. This UE grouping may be performed by the eNB periodically or when the UE receives the downlink data or transmits the uplink data, regardless of the transmission of the UE's immediate uplink data.

As shown in FIG. 5, based on the timing information of the UEs, the eNB may divide the timing distance zone into the timing distance zone A (500), the timing distance zone B (510), the timing distance zone C (520), and the timing distance zone D (530), and may group UE1, UE2, and UE3 located in the timing distance zone A (500) into the first UE group.

As described above, the timing distance zone may be set such that the difference ΔT of the propagation delay time between the UEs is within the CP duration. According to various carrier spacing and CP configurations, ΔT and the timing distance zone may be changed.

The eNB may allocate the same radio resource zone to at least one UE included in one UE group included in the same timing distance zone.

For example, each of the plurality of UEs included in the first UE group may transmit uplink data through the first radio resource zone (resource zone A) 505, and each of the plurality of UEs included in the second UE group may transmit uplink data through the second radio resource zone (resource zone B) 515. Also, each of the plurality of UEs included in the third UE group may transmit uplink data through the third radio resource zone (resource zone C) 525, and each of the plurality of UEs included in the fourth UE group may transmit uplink data through the fourth radio resource zone (resource zone D) 535. In this way, the difference in the reception timing of the uplink data transmitted by at least one UE included in one UE group in the eNB may be set within the CP duration, such that an interference between symbols may not occur.

As described above, a UE may not consider the uplink transmission timing of the other UEs, the uplink grant by the eNB, and the timing advance, but may consider only the implicit access timing to immediately transmit uplink data to the eNB based on the multiple overlapped access method through the radio resource allocated to the UE group including the UE. In this case, although the reception timing of the eNB in regard to transmission of the uplink data of each UE is different, the difference between the reception timings may be within the CP duration.

According to an embodiment of the present invention, a pre-defined radio resource zone (hereinafter, referred to as an allocated radio resource zone) to be allocated to each UE group may vary according to the system environment or the number of users accessing the eNB. For example, an allocation radio resource zone to be allocated to each UE group may be determined according to a timing distance zone (or a fractional timing distance zone) as shown in FIG. 5, and the allocation radio resource zone may be allocated to UE groups by time-division, frequency-division, and time-frequency division manner.

Specifically, when a time division method is used, the allocation radio resource zone may be allocated for each UE group based on various units such as symbols, slots, subframes, and frames. When the frequency division method is used, allocation radio resource zones may be allocated to each UE group based on various units such as a subcarrier, a subband, and a total-band. When the time-frequency division method is used, specific time resources and specific frequency resources may be allocated to the allocation radio resource zones for the UE group.

For example, referring to FIG. 5, when viewing only the first radio resource zone (resource zone A) 505 and the second radio resource zone (resource zone B) 515, the first radio resource zone (resource zone A) 505 and the second radio resource zone (resource zone B) 515 may be a radio resource zone divided by the frequency division method. Also, when viewing only the first radio resource zone (resource zone A) 505 and the third radio resource zone (resource zone C) 525, the first radio resource zone (resource zone A) 505 and the third radio resource zone (resource zone C) 525 may be a radio resource zone divided by the time-division method.

Also, when viewing the first radio resource zone (resource zone A) 505 and the second radio resource zone (resource zone B) 515, the third radio resource zone (resource zone C) 525 and the fourth radio resource zone (resource zone D) 535, the first radio resource zone (resource zone A) 505 and the second radio resource zone (resource zone B) 515, the third radio resource zone (resource zone C) 525 and the fourth radio resource zone (resource zone D) 535 may be radio resource zones divided by the time-frequency division method.

The allocation radio resource zones may also be allocated for each UE group using the entire resources without the above-described division.

As shown in FIG. 5, UE1, UE2, and UE3 included in the same timing distance zone A perform uplink transmission through the first radio resource zone (resource zone A) 505, and may share the same resource zone A. UEs included in one UE group transmit uplink data through the same radio resource zone. Accordingly, the eNB receiving uplink data needs to distinguish each of a plurality of uplink data transmitted by a plurality of UEs included in one UE group that transmits uplink data through the same radio resource zone.

A multiple overlapped access technology capable of Multi-User Detection (MUD) may be used for distinguishing each of a plurality of uplink data transmitted by a plurality of UEs by the eNB. For example, the plurality of UEs may overlappingly transmit each of the plurality of uplink data on the same resource based on IDMA, SCMA, Power Level NOMA, or the like.

Hereinafter, in an embodiment of the present invention, a time-frequency resource sharing method in an ultra-low latency asynchronous multiple access is disclosed.

Specifically, in order to reduce the time until reception of acknowledgment (ACK)/non-acknowledgment (NACK) signals transmitted in response to the transmission of uplink data, a latency from the occurrence point of the uplink traffic to the transmission completion point of the uplink traffic to the eNB needs to be minimized.

In order to minimize the latency until the reception of the ACK/NACK signals after the transmission of the uplink data, each UE needs to transmit the uplink data on the largest radio resource at the same time as occurrence of the uplink data. Accordingly, there is a need for a method for immediately transmitting uplink data without a loss of decoding rate while a plurality of UEs share limited radio resources. Hereinafter, in an embodiment of the present invention, a method for minimizing a latency until reception of ACK/NACK signals after transmission of uplink data is disclosed.

According to an embodiment of the present invention, disclosed is a method in which a plurality of UEs sharing limited radio resources immediately start transmitting uplink data and quickly complete transmission of uplink data.

UEs that desire to transmit different sizes of uplink data based on a transmission request of different uplink data may transmit uplink data to the eNB by the multiple overlapped access method capable of the MUD at the implicit access timing as described above.

In this case, the UEs may transmit uplink data through the radio resource zone of the UE group including the UE. From the eNB viewpoint, the uplink data transmitted by a UE may have a reception timing offset within the CP with other uplink data transmitted by other UEs included in the same UE group as the UE.

When the uplink data transmission method is used at this implicit timing, a UE may transmit the uplink data without considering the uplink transmission timing or resource occupancy of other UEs. The eNB may separate the uplink data transmitted from the UE based on the MUD at the symbol level.

The MUD method may differ according to the multiple overlapped access method used by the UE. The eNB may distinguish the uplink data of the UE from a plurality of uplink data received through the same radio resources through a Successive Interference Cancellation (SIC) method or a Parallel Interference Cancellation (PIC) method which is a repetitive decoding method.

Also, according to an embodiment of the present invention, the latency in terms of the air interface may be reduced based on the variable configuration for the limited resource zone.

When the proposed method is used, multiple users may perform immediate data transmission without a loss of decoding rate while sharing limited resources.

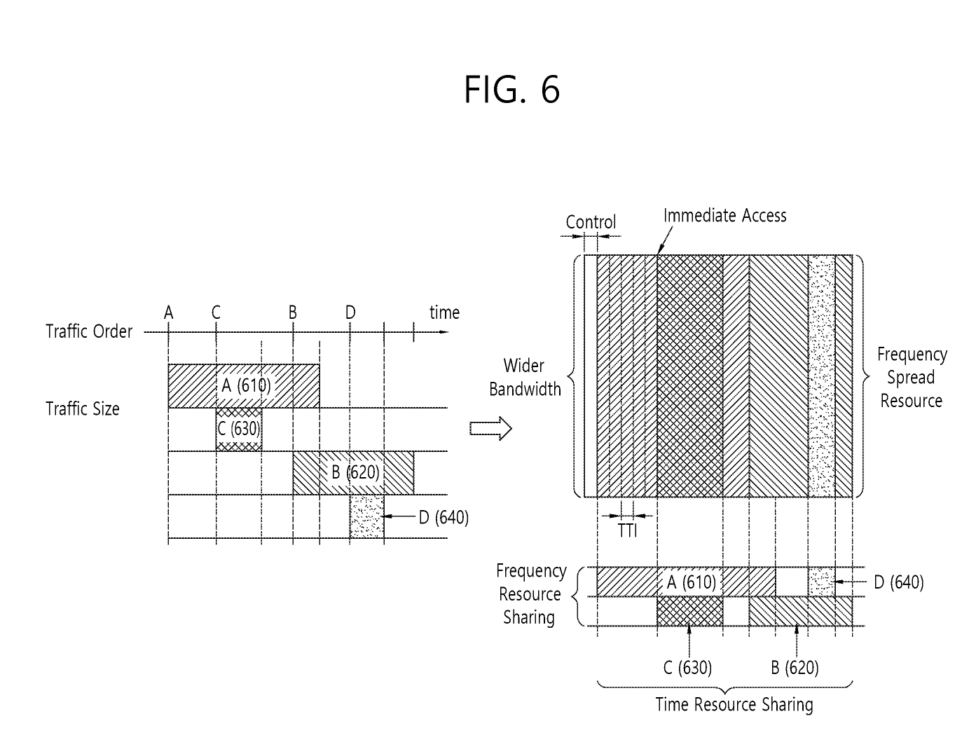

FIG. 6 is a conceptual view illustrating a method of transmitting uplink data of a plurality of UEs through a frequency spread resource according to an embodiment of the present invention.

In FIG. 6, a method of transmitting uplinks of a plurality of UEs for minimizing a latency until reception time point of ACK/NACK signals for uplink data after transmission of uplink data on frequency spread resources is disclosed.

A UE having transmission requests for different uplink data and different uplink data sizes may transmit uplink data to the eNB using a multiple overlapped access method that supports the MUD at the implicit access timing.

Referring to FIG. 6, a UE A in which a request for transmission of uplink data first occurs may transmit first uplink data 610 through a first radio resource. Next, a UE C may transmit second uplink data 620 through a second radio resource having a frequency resource and a time resource overlapped with the first radio resource. The frequency resource of the second radio resource may be entirely overlapped with the frequency resource of the first radio resource, and the time resource of the second radio resource may be partially overlapped with the time resource of the first radio resource.

Also, a UE B may transmit third uplink data 630 through a third radio resource having a frequency resource and a time resource overlapped with the first radio resource. The frequency resource of the third radio resource may be entirely overlapped with the frequency resource of the first radio resource, and the time resource of the third radio resource may be partially overlapped with the time resource of the first radio resource.

In addition, a UE D may transmit fourth uplink data 640 through a fourth radio resource having a frequency resource and a time resource overlapped with the third radio resource. The frequency resource of the fourth radio resource may be entirely overlapped with the frequency resource of the first radio resource, and the time resource of the fourth radio resource may be partially overlapped with the time resource of the third radio resource.

In this case, the uplink transmission timing of UE A, UE B, UE C, and UE D may be determined based on the implicit access timing.

In this manner, regardless of the size of the uplink data, UE A, UE B, UE C, and UE D may transmit the uplink data without considering uplink transmission timing and resource occupancy of other UEs when a transmission request for uplink data occurs.

The eNB receiving a plurality of uplink data at the same time may perform MUD at a symbol level. The MUD method may be different according to the multiple overlapped access method that is used, and may distinguish signals of multiple users based on a Successive Interference Cancelation (SIC) method or a Parallel Interference Cancelation (PIC) method which is a repetitive decoding method.

In the multiple overlapped access method of a plurality of UEs disclosed in FIG. 6, a plurality of UEs may transmit the uplink data by sharing the same (or overlapped) radio resource zone (or the same frequency resource). Accordingly, the radio resources may be variably utilized. As shown in FIG. 6, a resource block (RB) or a subband may be configured with a smaller transmission time interval (TTI) and a larger number of subcarriers or a broader bandwidth in order to achieve low latency in terms of the air interface.

For example, when 15 kHz that is the size of the subcarrier spacing of a legacy LTE system is extended and thus subcarrier spacing of 30 KHz and 60 KHz is defined, there may be a change in the size of the symbol duration. Even if the size of subcarrier spacing is changed, the multiple overlapped access method disclosed in the embodiment of the present invention may be supported.

Similarly, although the existing RB unit including the 12 subcarriers is changed to the RB unit including other numbers of subcarriers such as 10 or 14 subcarriers, the multiple overlapped access method disclosed in the embodiment of the present invention may be used. In a similar manner, the subband may also be variably configured.

Referring to FIG. 6, it may be assumed that the uplink data of UE A are generated at time t_{A} and the unit time of transmitting uplink data of a specific size is T_{A}. In this case, when scheduling for uplink transmission is performed based on a Single Carrier (SC)-Frequency Division Multiple Access (FDMA) method in the legacy LTE system, the time from transmission of uplink data to the reception of ACK/NACK for uplink data may be expressed as t_{TACK}=tA+t_{control}+TA/N_{carrier}/N_{symbol}.

Here, t_{control} may be a time for controlling scheduling such as receiving a grant for uplink transmission from the eNB and a timing advance. N_{carrier} and N_{symbol} are the number of frequency resource units (e.g., subcarriers) and number of time resource units (e.g., OFDM symbols) which UE A can use to transmit uplink data of T_{A} size, respectively.

On the other hand, according to an embodiment of the present invention, the transmission completion time may be expressed as t_{ACK}=t_{A}±t_{Implicit}+TA/(N_{carrier}*Nᵤₛₑᵣ)/N_{symbol}. Accordingly, the uplink traffic generation time t_{A} is the same, but as described above, since a control signal for separate access is not transmitted before access, it is clear that t_{Implicit}<<t_{control}. For example, the maximum value of t_{Implicit} is about 71.4 us, and t_{control} is about 4-8 ms based on legacy LTE. Also, since UE A can occupy all time/frequency resources within the radio resource zone, the transmission time for transmitting uplink data in proportion to the number of occupying UEs may be reduced to T_{A}/(N_{carrier}*Nᵤₛₑᵣ)/N_{symbol}. In FIG. 6, since the number of occupying UEs is 4, transmission time may be shortened to T_{A}/4. This example may be changed according to the variable utilization of radio resources, and there may be a difference in time shortening according to a parameter change of a channel coding method considering reduction of a decoding rate due to multiple overlapped access.

Hereinafter, a definition of a signal flow in terms of a transmitting end and a receiving end for an ultra-low latency service based on the implicit access timing and allocation of a radio resource zone according to an embodiment of the present invention is disclosed.

Specifically, each UE may transmit an essential control message to an eNB when an uplink traffic is generated. After transmission of the essential control message, the UE may transmit uplink data without considering the transmission of uplink data of another UE while being not controlled by the eNB.

When the control information of the eNB is received in the state where the transmission of the uplink data is not completed, the UE may also change the data transmission method according to the received control information to transmit. That is, when uplink data are generated by the UE, the UE may immediately transmit uplink data without waiting for signaling of separate control information from the eNB.

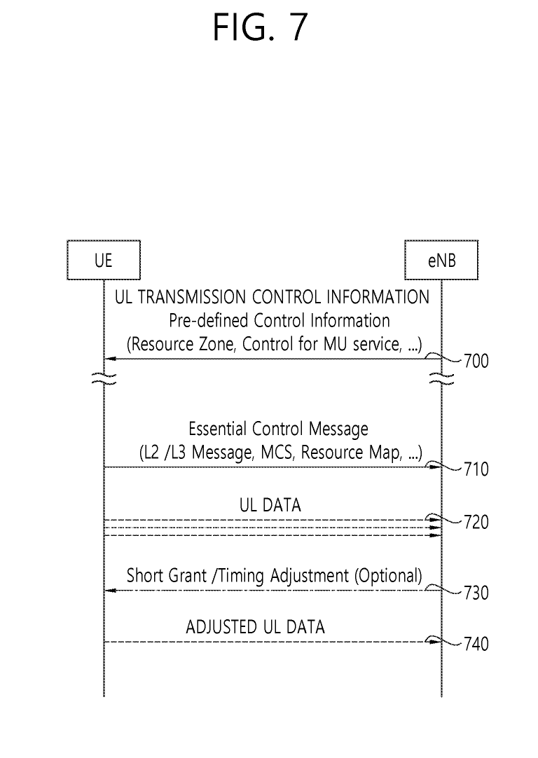

FIG. 7 is a flowchart illustrating a signal flow for an ultra low latency service according to an embodiment of the present invention.

In FIG. 7, a flow of a signal for simplifying a control signaling procedure for multiple connections of a plurality of UEs and for performing immediate data transmission of the UEs is disclosed.

Referring to FIG. 7, the eNB may transmit pre-defined uplink transmission control information 700 to the UE.

The uplink transmission control information 700 may include information on a radio resource zone to be allocated to each of a plurality of UEs and control information (e.g., implicit access timing related information) for uplink data transmission of each of a plurality of UEs.

As described above, the radio resource zones to be allocated to each of the plurality of UEs may be allocated based on the timing distance zone. For the uplink transmission according to the system environment, the timing distance zone may be subdivided, and may be configured into one zone without a division. In addition, the uplink transmission control information 700 may include control information for the multiple overlapped access method to distinguish a plurality of uplink data transmitted by a plurality of UEs on the overlapped time-frequency resources.

For example, information on the IDMA user-specific interleaver method or index, information on the SCMA codebook method or codeword index, and Information on the power control method or power level of a power level NOMA may be included in uplink transmission control information 700 as control information for the multiple overlapped access method, and may be transmitted by the eNB.

Here, the uplink transmission control information may be long-term control information, and may be independent of occurrence of uplink data.

When uplink data are generated in each of a plurality of UEs, only an essential control message 710 for network connection is transmitted, and uplink data 720 may be transmitted without any separate uplink grant or timing advance from the eNB.

As shown in FIG. 7, the essential control information transmitted by the UE may include an L (layer) 2/L (layer) 3 message for the network connection, Modulation and Coding Scheme (MCS) level that is used, and resource map information that is being currently used. The essential control information of the UE as a small amount of information that may affect the decoding rate of uplink data to be transmitted thereafter needs to be transmitted in consideration of a fixed MCS level or repetition that can ensure a high decoding rate.

In this case, the MCS level and the uplink transmission power of each of the plurality of UEs may be determined by the UE based on Channel Quality Indicator (CQI) information of a long-term viewpoint.

Specifically, each of the plurality of UEs may determine an MCS level based on Physical Downlink Control Channel (PDCCH) information or DL Received Signal Strength Indication (RSSI) information received before transmission of the uplink data 720, and may perform uplink transmission power control. Alternatively, UEs may transmit the uplink data 720 at an MCS level lower than the MCS level of the previously transmitted uplink data 720 and at a power level higher than the power level for transmission of the previously transmitted uplink data 720, thereby enhancing reception stability of the uplink data 720.

After the transmission of uplink data 720 of the UE, the MCS level and the power level which are initially determined based on a short grant and a timing advance 730 received through the PDCCH during the transmission time of the continuous uplink data 720 may be adjusted, and the UE may be synchronized.

For example, in FIG. 7, each of a plurality of UEs may transmit an essential control message 710 without scheduling between the plurality of UEs when uplink data 720 are generated. The essential control message may include MCS information and resource map information as L2/L3 messages. Each of the plurality of UEs may continuously transmit the uplink data 720 without any control by the eNB. The eNB receiving the essential control message 710 may transmit control information and timing advance information 730 about the MCS level/power level to each of the plurality of UEs based on the current uplink resource state and timing information.

Each of the plurality of UEs which is continuously transmitting the uplink data 720 without any control may perform change of the MCS level/power level based on the control information from a time point of receiving the control information (e.g., control information and timing advance information on the MCS level/power level) 730 from the eNB, and may perform the timing advance to transmit the adjusted uplink data 740. The control information transmission/reception of the eNB may be selectively performed between the eNB and each of the plurality of UEs.

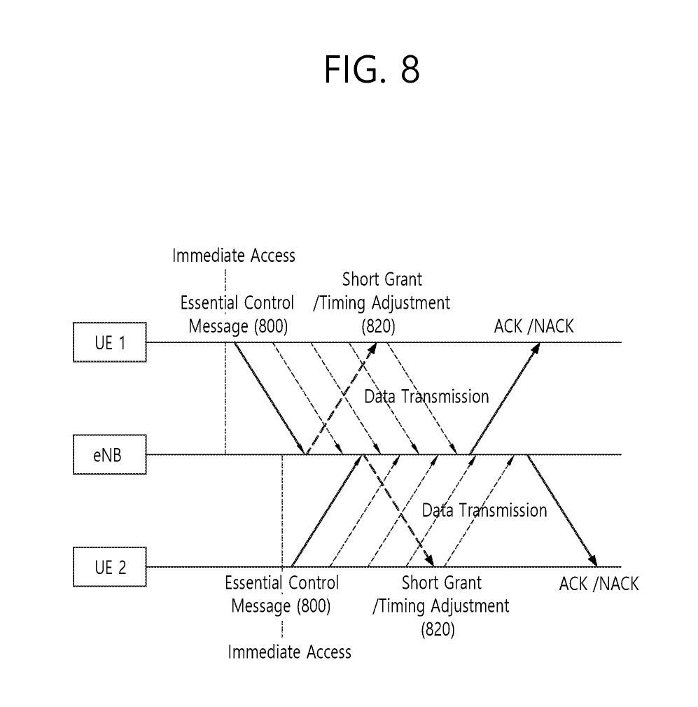

FIG. 8 is a conceptual view illustrating signaling for an ultra low latency service in a multiple access method according to an embodiment of the present invention.

Referring to FIG. 8, each of UE1 and UE2 may transmit essential control messages 800 and 810 to the eNB, and then may transmit uplink data to the eNB. The UE1 and the UE2 may transmit the uplink data to the eNB through the radio transmission resource allocated based on the timing distance zone at the implicit access timing.

The UE1 and the UE2 may receive short grant and timing adjustment (or timing advance) information 820 and 830 from the eNB during the transmission of uplink data to the eNB.

The UE1 and the UE2 may perform the change of the MCS level/power level based on the received short grant and timing adjustment information 820 and 830, and may perform the timing advance to continuously transmit data.

When the uplink transmission method is performed, asynchronism may be controlled without receiving a scheduling request for multi-user transmission and an uplink grant such that uplink transmission can be performed. In addition, the reception time of the ACK/NACK for the data transmission is reduced, such that the UE's traffic transfer completion time point can be minimized.

When the eNB continuously decodes the uplink data received from the plurality of UEs and recognizes the decoding success or the reception of the uplink data, the eNB may perform additional control signaling for maintaining connection with the UE.

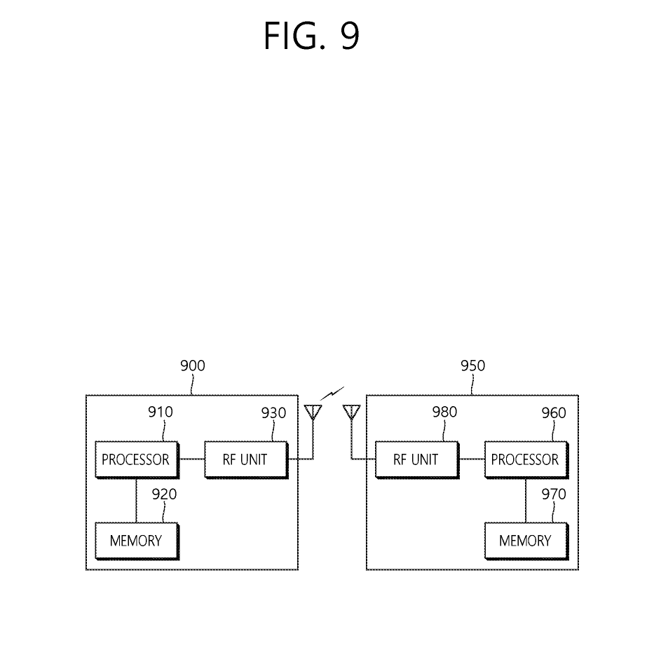

FIG. 9 is a view illustrating a wireless device to which an embodiment of the present invention may be applied.

Referring to FIG. 9, a radio device may be an eNB 900 and a UE 950 capable of implementing the above-described embodiments.

The eNB 900 includes a processor 910, a memory 920, and an RF unit 930.

The RF unit 930 may be connected to the processor 910 to transmit/receive a radio signal.

The processor 910 may implement the functions, processes, and/or methods proposed in the present invention. For example, the processor 910 may be implemented to perform operations of the eNB according to the above-described embodiments of the present invention. The processor 910 may perform the operations of the eNBs disclosed in the embodiments of FIGS. 1 to 8.

For example, the processor 910 may be implemented to group each of a plurality of UEs into one UE group of a plurality of UE groups considering each of a plurality of propagation delays of each of a plurality of UEs, and to receive each of a plurality of uplink data transmitted by each of a plurality of UE groups on each of a plurality of radio resources allocated for each of the plurality of UE groups at an implicit access timing, and to transmit each of a plurality of ACK/NACK signals in response to each of a plurality of uplink frames to each of the plurality of UE groups. The implicit access timing may be periodically defined into units of symbols for synchronization of transmission time points of the plurality of uplink data.

Also, the processor 910 may determine each of the plurality of propagation delays of each of the plurality of UEs, determine one propagation delay range in which each of the plurality of propagation delays is included among the plurality of propagation delay ranges, and determine each of the plurality of UEs as one UE group among the plurality of UE groups based on one propagation delay range. Each of the plurality of propagation delay ranges may be determined based on a Cyclic Prefix (CP) duration of a symbol.

In addition, the processor 910 may be implemented to transmit information about the implicit access timing and information about each of a plurality of radio resources allocated for each of the plurality of UE groups to each of the plurality of UEs.

The UE 950 includes a processor 960, a memory 970, and a communication unit 980.

The RF unit 980 may be connected to the processor 960 to transmit/receive a radio signal.

The processor 960 may implement the functions, processes, and/or methods proposed in the present invention. For example, the processor 960 may be implemented to perform operations of the UE according to the above-described embodiments of the present invention. The processor 960 may perform the operations of the UE 950 in the embodiments of FIGS. 1 to 8.

For example, the processor 960 may be implemented to receive information about the implicit access timing and information about each of a plurality of radio resources allocated for each of a plurality of UE groups, and transmit the uplink data on the radio resource allocated for each the UE group including UEs at the implicit access timing.

The processors 910 and 960 may include Application-Specific Integrated Circuits (ASICs), other chipsets, logic circuits, data processing devices, and/or converters for mutually converting baseband signals and radio signals. The memories 920 and 970 may include Read-Only Memory (ROM), Random Access Memory (RAM), flash memory, memory card, storage media, and/or other storage devices. The RF units 930 and 980 may include one or more antennas for transmitting and/or receiving radio signals.

When the embodiments are implemented in software, the above-described techniques may be implemented as a module (process, function, etc.) that performs the above-described functions. The module may be stored in the memories 920 and 970, and may be executed by the processors 910 and 960. The memories 920 and 970 may be internal or external to the processors 910 and 960, and may be connected to the processors 910 and 960 in various well-known ways.

When uplink transmission of a plurality of UEs is performed, asynchronism is controlled without receiving a scheduling request and an uplink grant to an e-Node B (eNB), such that uplink transmission can be performed. In addition, the reception time of the ACK/NACK for the data transmission is reduced, such that the UE's traffic transfer completion time point can be minimized.

What is claimed is:

1. An asynchronous-based multiple access method for a low latency service, the method comprising:
grouping, by an eNB (eNode B), each of a plurality of User Equipments (UEs) into one UE group of a plurality of UE groups in consideration of each of a plurality of propagation delays of each of the plurality of UEs;
receiving, by the eNB, each of a plurality of uplink data transmitted by each of the plurality of UE groups on each of a plurality of radio resources allocated for each of the plurality of UE groups at an implicit access timing; and
transmitting, by the eNB, each of a plurality of acknowledgment (ACK)/non-acknowledgment (NACK) signals in response to each of a plurality of uplink frames to each of the plurality of UE groups,
wherein the implicit access timing is periodically defined into units of symbols for synchronization of transmission time points of the plurality of uplink data.

2. The method of claim 1, wherein the grouping of each of the plurality of UEs into the one UE group of the plurality of UE groups comprises:
determining, by the eNB, each of the plurality of propagation delays of each of the plurality of UEs;
determining, by the eNB, one propagation delay range in which each of the plurality of propagation delays is comprised among a plurality of propagation delay ranges; and
determining, by the eNB, each of the plurality of UEs as the one UE group of the plurality of UE groups based on the one propagation delay range.

3. The method of claim 2, wherein each of the plurality of propagation delay ranges is determined based on a Cyclic Prefix (CP) duration of the symbol.

4. The method of claim 2, further comprising transmitting, by the eNB, information on the implicit access timing and information on each of the plurality of radio resources allocated for each of the plurality of UE groups to each of the plurality of UEs.

5. An eNode B (eNB) for an asynchronous-based multiple access for a low latency service, the eNB comprising:
a Radio Frequency (RF) unit communicating with a UE (User Equipment); and
a processor operably connected to the RF unit,
wherein the processor groups each of a plurality of UEs into one UE group of a plurality of UE groups in consideration of each of a plurality of propagation delays of each of the plurality of UEs,
receives each of a plurality of uplink data transmitted by each of the plurality of UE groups on each of a plurality of radio resources allocated for each of the plurality of UE groups at an implicit access timing, and
transmits each of a plurality of acknowledgment (ACK)/non-acknowledgment (NACK) signals in response to each of a plurality of uplink frames to each of the plurality of UE groups, and
the implicit access timing is periodically defined into units of symbols for synchronization of transmission time points of the plurality of uplink data.

6. The eNB of claim 5, wherein the processor is configured to determine each of the plurality of propagation delays of each of the plurality of UEs,
determine one propagation delay range in which each of the plurality of propagation delays is comprised among a plurality of propagation delay ranges, and
determine each of the plurality of UEs as the one UE group of the plurality of UE groups based on the one propagation delay range.

7. The eNB of claim 6, wherein each of the plurality of propagation delay ranges is determined based on a Cyclic Prefix (CP) duration of the symbol.

8. The eNB of claim 6, wherein the processor is configured to transmit information on the implicit access timing and information on each of the plurality of radio resources allocated for each of the plurality of UE groups to each of the plurality of UEs.
